(19) United States
(12) Patent Application Publication
(10) Pub. No.: US 2024/0057097 A1
(43) Pub. Date: Feb. 15, 2024

(54) SLOT PATTERN FOR REPETITIONS OF SLOT TYPE

(71) Applicant: QUALCOMM Incorporated, San Diego, CA (US)

(72) Inventors: Muhammad Sayed Khairy ABDELGHAFFAR, San Jose, CA (US); Gokul SRIDHARAN, Sunnyvale, CA (US); Qian ZHANG, Basking Ridge, NJ (US); Abdelrahman Mohamed Ahmed Mohamed IBRAHIM, San Diego, CA (US); Ahmed Attia ABOTABL, San Diego, CA (US); Seyedkianoush HOSSEINI, San Diego, CA (US); Hung Dinh LY, San Diego, CA (US); Yan ZHOU, San Diego, CA (US)

(21) Appl. No.: 17/885,398

(22) Filed: Aug. 10, 2022

(51) Int. Cl. H04W 72/12; H04B 1/00

(52) U.S. Cl. CPC H04W 72/1289; H04B 1/0067

(57) ABSTRACT

Various aspects of the present disclosure generally relate to wireless communication. In some aspects, a user equipment (UE) may receive an indication of a slot pattern for repetitions of a transport block in slots of a specified slot type. The UE may receive scheduling information that schedules the repetitions. The UE may transmit or receive the repetitions according to the slot pattern based at least in part on the repetitions being for the specified slot type. Numerous other aspects are described.

### FIELD OF THE DISCLOSURE

Aspects of the present disclosure generally relate to wireless communication and specifically to techniques and apparatuses for indicating a slot pattern for repetitions of a specified slot type.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MB/10) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a slot pattern for repetitions of a transport block in slots of a specified slot type. The method may include receiving scheduling information that schedules the repetitions. The method may include transmitting or receiving the repetitions according to the slot pattern based at least in part on the repetitions being for the specified slot type.

Some aspects described herein relate to a method of wireless communication performed by a network entity. The method may include transmitting an indication of a slot pattern for repetitions of a transport block in slots of a specified slot type. The method may include transmitting the scheduling information that schedules the repetitions. The method may include transmitting or receiving the repetitions according to the slot pattern based at least in part on the repetitions being for the specified slot type.

Some aspects described herein relate to a UE for wireless communication. The UE may include a memory and one or more processors coupled to the memory. The one or more processors may be configured to receive an indication of a slot pattern for repetitions of a transport block in slots of a specified slot type. The one or more processors may be configured to receive scheduling information that schedules the repetitions. The one or more processors may be configured to transmit or receive the repetitions according to the slot pattern based at least in part on the repetitions being for the specified slot type.

Some aspects described herein relate to a network entity for wireless communication. The network entity may include a memory and one or more processors coupled to the memory. The one or more processors may be configured to transmit an indication of a slot pattern for repetitions of a transport block in slots of a specified slot type. The one or more processors may be configured to transmit the scheduling information that schedules the repetitions. The one or more processors may be configured to transmit or receive the repetitions according to the slot pattern based at least in part on the repetitions being for the specified slot type.

Some aspects described herein relate to a non-transitory computer-readable medium that stores a set of instructions for wireless communication by a UE. The set of instructions, when executed by one or more processors of the UE, may cause the UE to receive an indication of a slot pattern for repetitions of a transport block in slots of a specified slot type. The set of instructions, when executed by one or more processors of the UE, may cause the UE to receive scheduling information that schedules the repetitions. The set of instructions, when executed by one or more processors of the UE, may cause the UE to transmit or receive the repetitions according to the slot pattern based at least in part on the repetitions being for the specified slot type.

Some aspects described herein relate to a non-transitory computer-readable medium that stores a set of instructions for wireless communication by a network entity. The set of instructions, when executed by one or more processors of the network entity, may cause the network entity to transmit an indication of a slot pattern for repetitions of a transport block in slots of a specified slot type. The set of instructions, when executed by one or more processors of the network entity, may cause the network entity to transmit the scheduling information that schedules the repetitions. The set of instructions, when executed by one or more processors of the network entity, may cause the network entity to transmit or receive the repetitions according to the slot pattern based at least in part on the repetitions being for the specified slot type.

Some aspects described herein relate to an apparatus for wireless communication. The apparatus may include means for receiving an indication of a slot pattern for repetitions of a transport block in slots of a specified slot type. The apparatus may include means for receiving scheduling information that schedules the repetitions. The apparatus may include means for transmitting or receiving the repetitions according to the slot pattern based at least in part on the repetitions being for the specified slot type.

Some aspects described herein relate to an apparatus for wireless communication. The apparatus may include means for transmitting an indication of a slot pattern for repetitions of a transport block in slots of a specified slot type. The apparatus may include means for transmitting the scheduling information that schedules the repetitions. The apparatus may include means for transmitting or receiving the repetitions according to the slot pattern based at least in part on the repetitions being for the specified slot type.

Aspects generally include a method, apparatus, system, computer program product, non-transitory computer-readable medium, user equipment, base station, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example disaggregated base station architecture, in accordance with the present disclosure.

FIGS. 4A-4C are diagrams illustrating examples of full-duplex communication in accordance with the present disclosure.

FIG. 5 is a diagram illustrating an example of full-duplex communication modes, in accordance with the present disclosure.

FIG. 6 is a diagram illustrating examples of full-duplex communication, in accordance with the present disclosure.

FIG. 7 is a diagram illustrating an example of a slot pattern, in accordance with the present disclosure.

FIG. 8 is a diagram illustrating examples of slot patterns for repetitions based on slot type, in accordance with the present disclosure.

FIG. 9 is a diagram of an example associated with indicating a repetition slot pattern, in accordance with the present disclosure.

FIG. 10 is a diagram illustrating examples of slot patterns for repetitions based on slot type, in accordance with the present disclosure.

FIG. 11 is a diagram illustrating an example of splitting slot types for repetitions, in accordance with the present disclosure.

FIG. 12 is a diagram illustrating an example of scheduling repetitions, in accordance with the present disclosure.

FIG. 13 is a diagram illustrating an example process performed, for example, by a UE, in accordance with the present disclosure.

FIG. 14 is a diagram illustrating an example process performed, for example, by a network entity, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

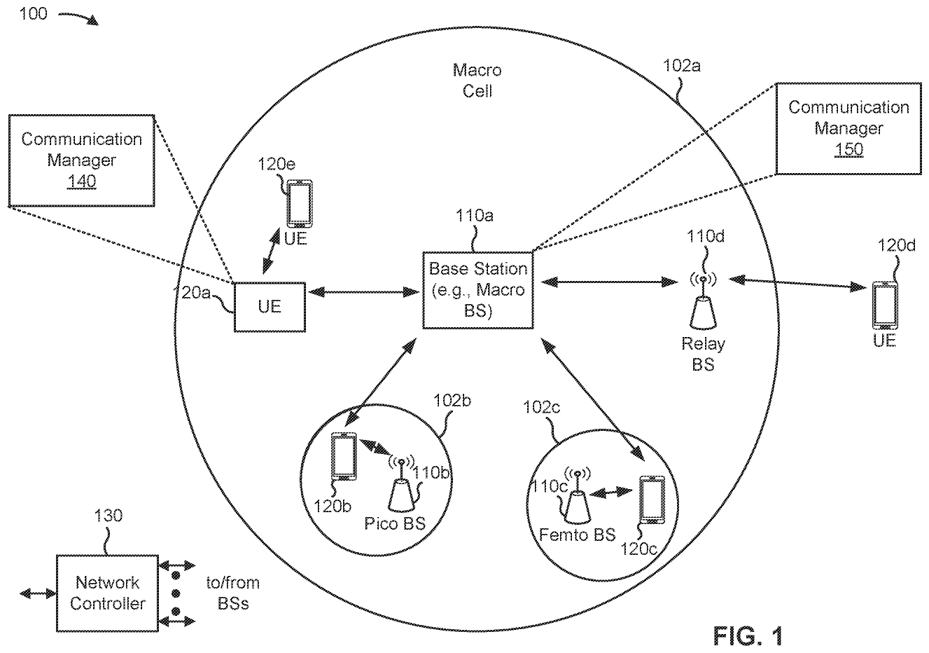

FIG. 1 is a diagram illustrating an example of a wireless network in accordance with the present disclosure. The wireless network 100 may be or may include elements of a 5G (e.g., NR) network or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some aspects, the term “base station” (e.g., the base station 110) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move in accordance with the location of a base station 110 that is mobile (e.g., a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (e.g., a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (e.g., one or more processors) and the memory components (e.g., a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (e.g., FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive an indication of a slot pattern for repetitions of a transport block in slots of a specified slot type. The communication manager 140 may receive scheduling information that schedules the repetitions and transmit or receive the repetitions according to the slot pattern based at least in part on the repetitions being for the specified slot type. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit an indication of a slot pattern for repetitions of a transport block in slots of a specified slot type. The communication manager 150 may transmit the scheduling information that schedules the repetitions and transmit or receive the repetitions according to the slot pattern based at least in part on the repetitions being for the specified slot type. Additionally, or alternatively, the communication manager 150 may perform one or more other operations described herein.

As indicated above, FIG. 1 is provided as an example. Other examples may differ from what is described with regard to FIG. 1.

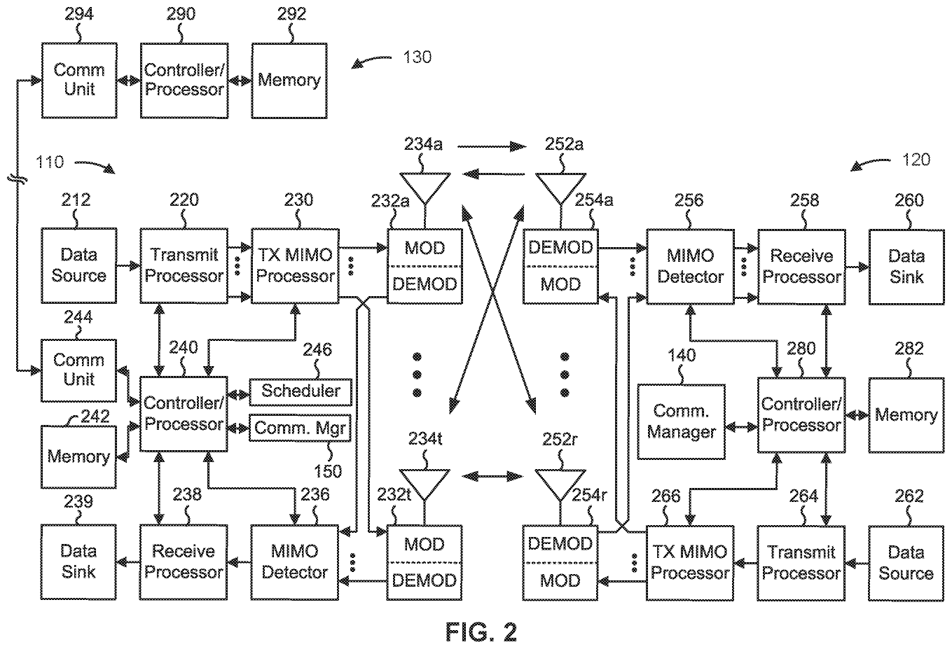

FIG. 2 is a diagram illustrating an example base station 110 in communication with a UE 120 in a wireless network in accordance with the present disclosure. The base station 110 may correspond to the base station 110 of FIG. 1. Similarly, the UE 120 may correspond to the UE 120 of FIG. 1. The base station 110 may be equipped with a set of antennas 234a through 234t, such as T antennas (T>1). The UE 120 may be equipped with a set of antennas 252a through 252r, such as R antennas (R>1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (e.g., for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (e.g., the controller/processor 280) and the memory 282 to perform aspects of any of the methods described herein.

At the base station 110, the uplink signals from UE 120 or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244.

The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (e.g., the controller/processor 240) and the memory 242 to perform aspects of any of the methods described herein.

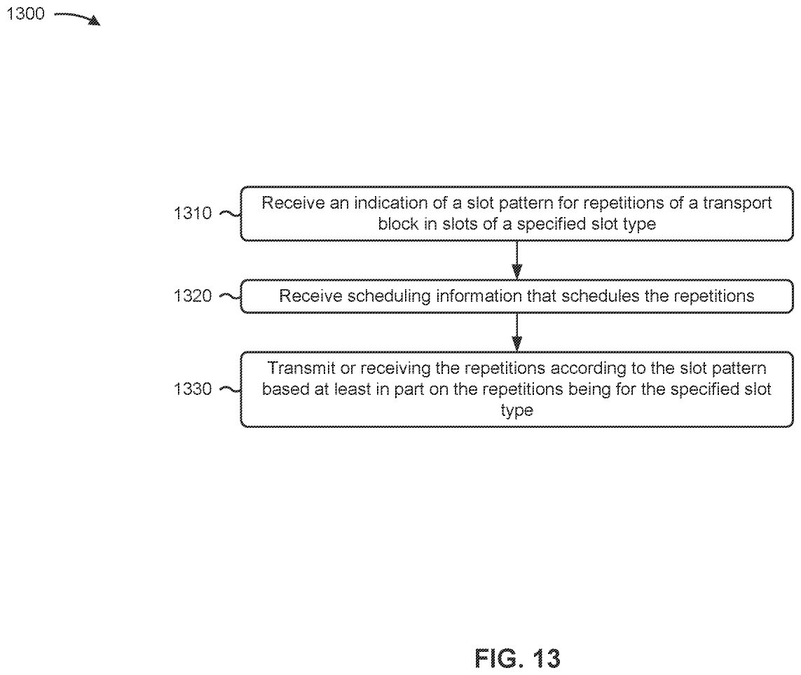

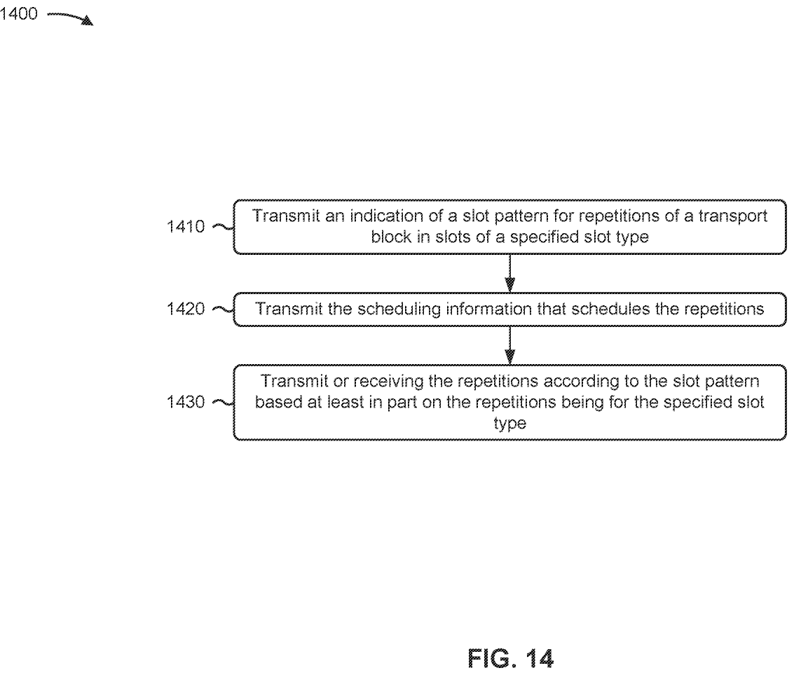

The controller/processor of a network entity (e.g., controller/processor 240 of the base station 110), the controller/processor 280 of the UE 120, or any other component(s) of FIG. 2 may perform one or more techniques associated with UE subband filtering, as described in more detail elsewhere herein. For example, the controller/processor 240 of the base station 110, the controller/processor 280 of the UE 120, or any other component(s) of FIG. 2 may perform or direct operations of, for example, process 1300 of FIG. 13, process 1400 of FIG. 14, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (e.g., code or program code) for wireless communication. For example, the one or more instructions, when executed (e.g., directly, or after compiling, converting, or interpreting) by one or more processors of the base station 110 or the UE 120, may cause the one or more processors, the UE 120, or the base station 110 to perform or direct operations of, for example, process 1300 of FIG. 13, process 1400 of FIG. 14, or other processes as described herein. In some examples, executing instructions may include running the instructions, converting the instructions, compiling the instructions, or interpreting the instructions, among other examples.

In some aspects, the UE 120 includes means for receiving an indication of a slot pattern for repetitions of a transport block in slots of a specified slot type; means for receiving scheduling information that schedules the repetitions; and/or means for transmitting or receiving the repetitions according to the slot pattern based at least in part on the repetitions being for the specified slot type. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting an indication of a slot pattern for repetitions of a transport block in slots of a specified slot type; means for transmitting the scheduling information that schedules the repetitions; and/or means for transmitting or receiving the repetitions according to the slot pattern based at least in part on the repetitions being for the specified slot type. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (e.g., within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

As indicated above, FIG. 2 is provided as an example. Other examples may differ from what is described with regard to FIG. 2.

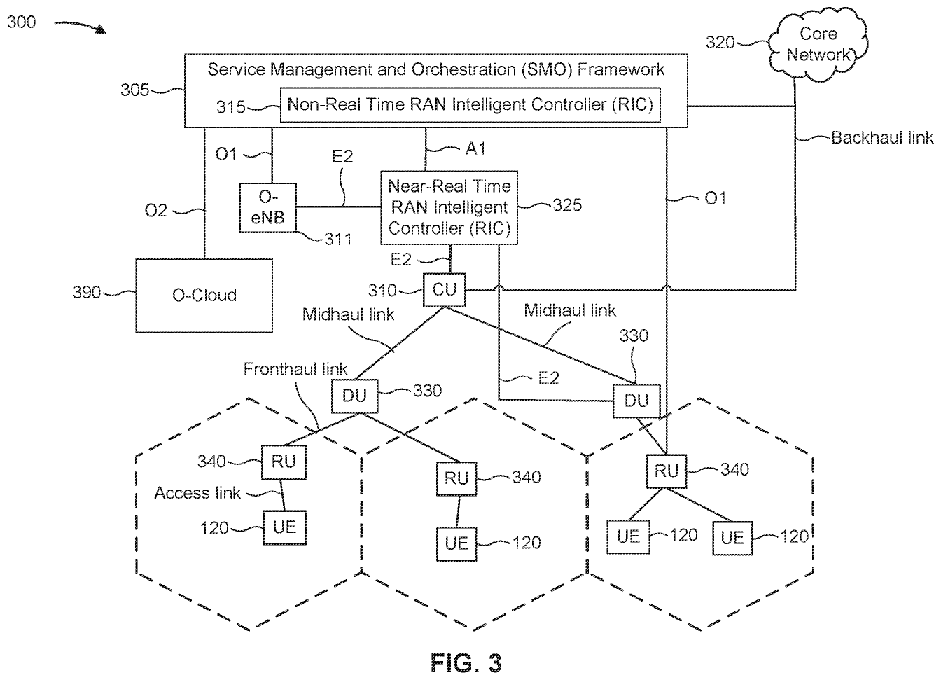

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (e.g., Central Unit—User Plane (CU-UP) functionality), control plane functionality (e.g., Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which may also be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based at least in part on a functional split (e.g., a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

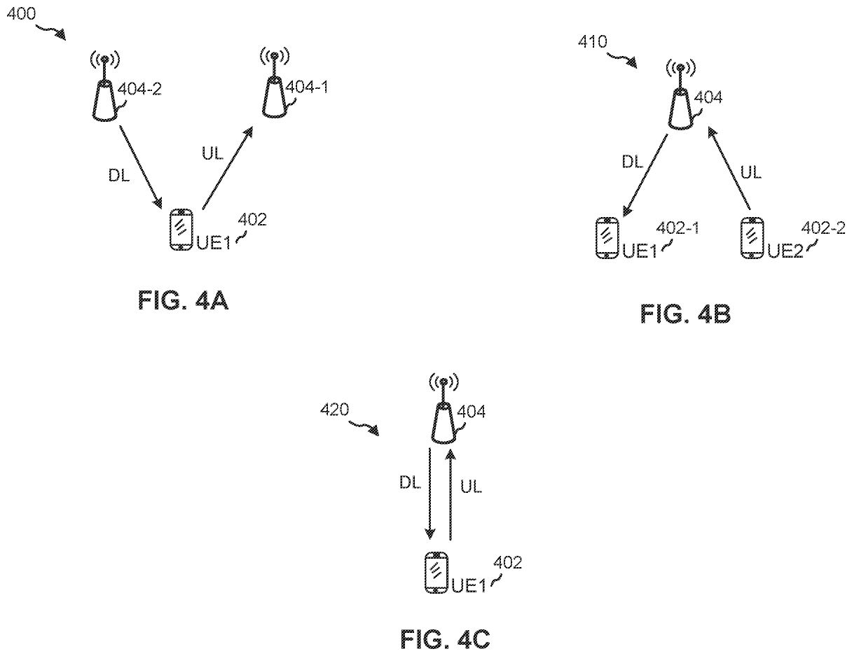

FIGS. 4A-4C are diagrams illustrating examples of full-duplex (FD) communication in accordance with the present disclosure. A first full-duplex scenario 400 depicted in FIG. 4A includes a UE1 402 and two base stations (e.g., network entities or TRPs) 404-1, 404-2, where the UE1 402 is sending uplink transmissions to base station 404-1 and is receiving downlink transmissions from base station 404-2. In the first full-duplex scenario 400 of FIG. 4A, FD is enabled for the UE1 402, but not for the base stations 404-1, 404-2. A second full-duplex scenario 410 depicted in FIG. 4B includes two UEs, shown as UE1 402-1 and UE2 402-2, and a base station 404, where the UE1 402-1 is receiving a downlink transmission from the base station 404 and the UE2 402-2 is transmitting an uplink transmission to the base station 404. In the second full-duplex scenario 410, FD is enabled for the base station 404, but not for UE1 402-1 and UE2 402-2. A third full-duplex scenario 420 is depicted in FIG. 4C that includes a UE1 402 and a base station 404, where the UE1 402 is receiving a downlink transmission from the base station 404 and the UE1 402 is transmitting an uplink transmission to the base station 404. In the third full-duplex scenario 420, FD is enabled for both the UE1 402 and the base station 404.

As indicated above, FIGS. 4A-4C provide some examples. Other examples may differ from what is described with regard to FIGS. 4A-4C.

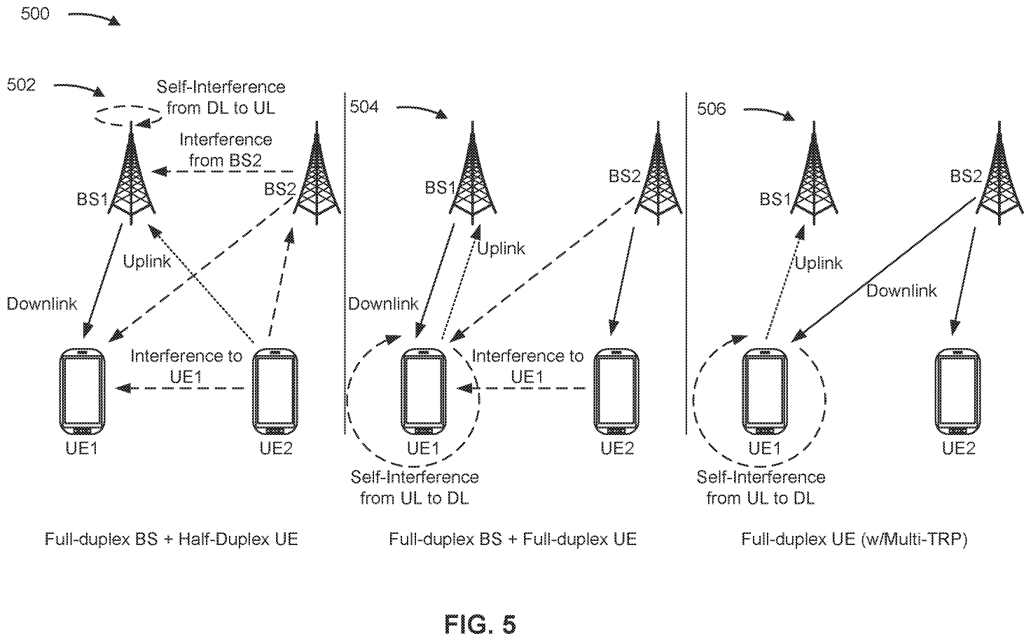

FIG. 5 is a diagram illustrating an example of full-duplex communication modes 500, in accordance with the present disclosure. In a first mode 502, a first network entity (shown as BS1) and a second network entity (shown as BS2) may be full-duplex devices (e.g., may be capable of communicating in a full-duplex manner). A first UE and a second UE may be half duplex UEs (e.g., may not be capable of communicating in a full-duplex manner). The first network entity may perform downlink transmissions to the first UE, and the first network entity may receive uplink transmissions from the second UE. The first network entity may experience self-interference (SI) from a downlink to an uplink based at least in part on the downlink transmissions to the first UE and the uplink transmissions received from the second UE. The first network entity may experience interference from the second network entity. The first UE may experience cross-link interference (CLI) from the second network entity and the second UE.

In a second mode 504, a first network entity and a second network entity may be full-duplex devices. A first UE and a second UE may be full-duplex UEs. The first network entity may perform downlink transmissions to the first UE, and the first network entity may receive uplink transmissions from the first UE. The first UE may experience SI from an uplink to a downlink based at least in part on the downlink transmissions from the first network entity and the uplink transmissions to the first network entity. The first UE may experience CLI from the second network entity and the second UE.

In a third mode 506, a first UE and a second UE may be full-duplex UEs and may communicate in a multi-TRP configuration. A first network entity may receive uplink transmissions from the first UE, and a second network entity may perform downlink transmissions to the first UE and the second UE. The first UE may experience SI from an uplink to a downlink based at least in part on the uplink transmissions to the first network entity and the downlink transmissions from the second network entity.

As indicated above, FIG. 5 is provided as an example. Other examples may differ from what is described with regard to FIG. 5.

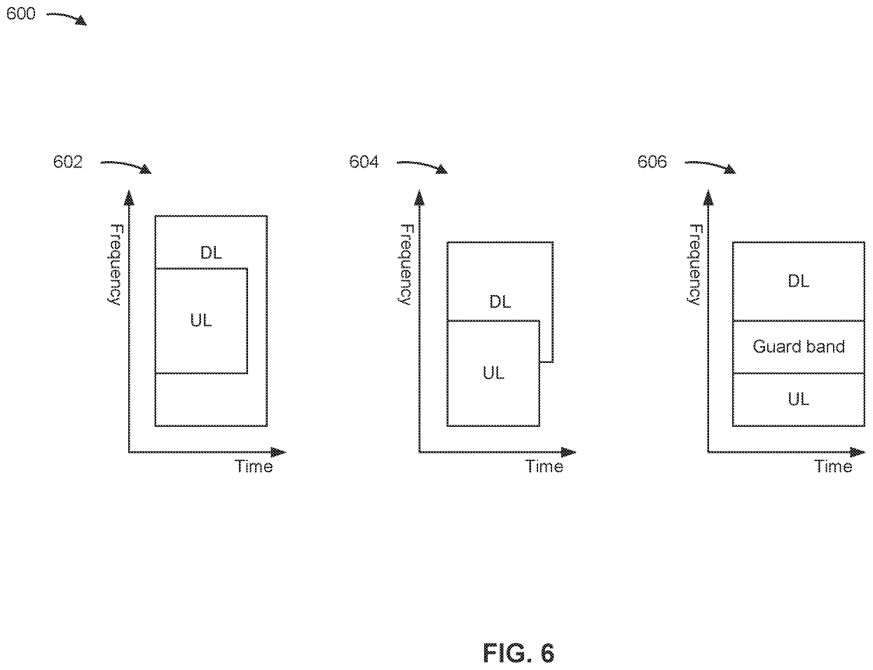

FIG. 6 is a diagram illustrating examples of full-duplex communication 600, in accordance with the present disclosure. In some cases, a wireless communication device (such as a UE or a network entity) may support full-duplex operations. Full-duplex operations may include the wireless communication device transmitting and receiving at approximately the same time.

A UE may operate in an in-band full-duplex mode. In the in-band full-duplex mode, the UE may transmit and receive on a same time and frequency resource. An uplink and a downlink may share the same time and frequency resource. For example, in a first full-duplex communication 602, a time and frequency resource for the uplink may fully overlap with a time and frequency resource for the downlink. As another example, in a second full-duplex communication 604, a time and frequency resource for the uplink may partially overlap with a time and frequency resource for the downlink.

Full-duplex operations may include a subband full-duplex (SBFD) mode. The SBFD mode may also be referred to as a subband frequency division duplex mode or a flexible duplex mode. SBFD communication 606 shows that the wireless communication device may transmit and receive at a same time (in the same SBFD slot), but the wireless communication device may transmit and receive on different frequency domain resources. For example, a network entity may be operating in an SBFD mode. The network entity may schedule a first UE to receive a downlink communication in an SBFD slot. The network entity may schedule a second UE to transmit an uplink communication in the same SBFD slot. However, the uplink communication may cause interference for the first UE that is receiving the downlink communication. To address this, a downlink time/frequency resource in the SBFD slot may be separated (e.g., in time or frequency) from an uplink time/frequency resource in the SBFD slot by a gap, which may function to reduce self-interference and improve latency and uplink coverage. The gap may be a frequency offset or a frequency gap (guard band) between downlink time/frequency resources and uplink time/frequency resources in the same SBFD slot.

In some cases, a slot pattern may include a combination of downlink slots, uplink slots, or SBFD slots.

As indicated above, FIG. 6 is provided as an example. Other examples may differ from what is described with regard to FIG. 6.

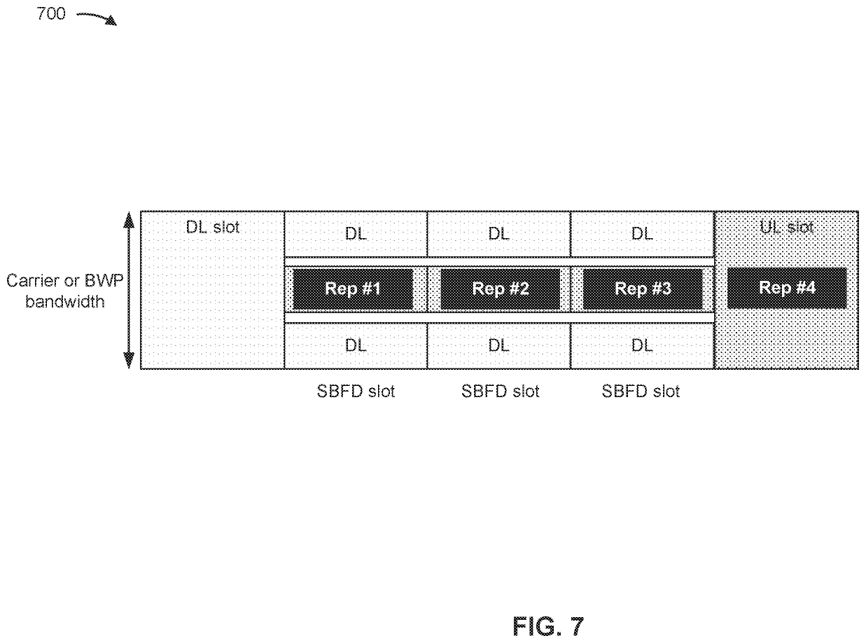

FIG. 7 is a diagram illustrating an example 700 of a slot pattern, in accordance with the present disclosure.

To increase reliability, a transport block or other communication may be repeated multiple times, and these may be referred to as repetitions. The repetitions may be for physical uplink shared channel (PUSCH) communications and for physical uplink control channel (PUCCH) communications. The repetitions may be for physical downlink shared channels (PDSCH). A UE may transmit or receive the repetitions using a configured slot pattern. The configured slot pattern may include a combination of downlink slots, uplink slots, full-duplex slots, or SBFD slots within a bandwidth of a carrier (e.g., a component carrier (CC) bandwidth or a channel bandwidth) or a bandwidth of a bandwidth part (BWP). Example 700 shows four repetitions of a transport block in multiple slots, including in three SBFD slots and one uplink slot (time division duplexing (TDD) slot).

Although the UE may currently transmit repetitions in slots of different types (TDD vs. SBFD), the different slot types can have different uplink qualities due to self-interference and inter-gNB interference that exists in the SBFD slot. In that sense, using the same MCS and transmit power across the repetitions in a mix of TDD and SBFD slots may not give the same target performance across the slots.

As indicated above, FIG. 7 is provided as an example. Other examples may differ from what is described with regard to FIG. 7.

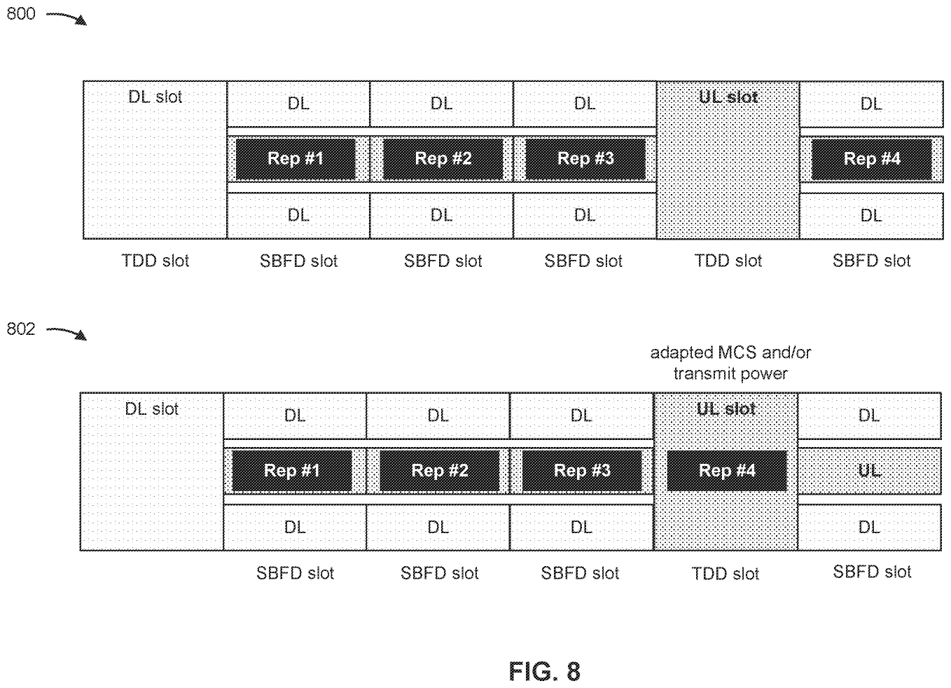

FIG. 8 is a diagram illustrating examples 800 and 802 of slot patterns for repetitions based on slot type, in accordance with the present disclosure.

According to various aspects described herein, the UE may enhance the transmission or reception of repetitions by using a repetition slot pattern that is based at least in part on the slot type. In some aspects, the UE may use a repetition slot pattern for repetitions in slots of a specified slot type. The repetition slot pattern may be within and different than a configured slot pattern that is available for all communications (indicated by a slot format indicator (SFI)). The repetition slot pattern may be limited to repetitions of only one slot type. As a result, the UE may achieve the same target performance for communications across repetitions.

In some aspects, the UE may use a repetition slot pattern of two slot types but adapt the MCS or transmit power for one of the slot types. As a result, the UE may achieve a better target performance across repetitions. For example, the UE may add a power offset to an uplink transmission in an SBFD slot. The maximum transmit power may be higher for an SBFD slot type. The maximum power reduction (MPR) for an SBFD slot type may be lower than for a TDD slot type. The MPR may be how much a transmit power may be reduced from a maximum power. In another example, repetitions in SBFD slots may have a lower MCS than the repetitions in TDD slots. The network entity may configure repetitions in SBFD with a greater transmit power than TDD slots. For PUSCH communications, the network entity may experience SI and inter-gNB CLI, while for a physical downlink shared channel (PDSCH), the UE may suffer from inter-UE CLI. In some aspects, the UE may receive an indication of an MCS for the specified slot type, where the MCS for the specified slot type is different than an MCS for another slot type. The UE may determine a size of the transport block based at least in part on the MCS.

In some aspects, for PxSCH (PUSCH or PDSCH) repetitions across different slot types, the network entity may transmit an indication of different MCS values for SBFD slots and for TDD slots. The indication may be explicit, having two MCS bitfields in the downlink control information (DCI) or one MCS value and a differential one (MCs delta). The indication may be based on an RRC configuration (e.g., fixed MCS delta). This may be applicable to RRC-based configured grant PUSCH (CG-PUSCH). The same MCS bitfield in DCI may be interpreted differently in each slot type. For example, there may be two different MCS look-up tables or two RRC configured MCS tables for TDD and SBFD slots. In some aspects, a transport block size may be determined based on a minimum of MCSs for slot types. There may be two transport block sizes for the two slot types, which may be applicable to a single DCI that schedules multiple PDSCH or PUSCH transport blocks. Note that PxSCH repetition may refer to either higher-layer configured repetition (e.g., semi-persistent (SPS) or CG) or dynamically granted repetition (e.g., downlink and uplink DCI formats). PUSCH repetition may refer to PUSCH repetition Type A and Type B. The repetitions may be either inter-slot or intra-slot (PUSCH Type B).

In some aspects, the UE may control the quantity of each slot type in a repetition slot pattern. For example, the repetition slot pattern may allow for three full duplex (e.g., SBFD) slots and one TDD slot. As a result, the UE may have better control of the target performance across repetitions.

Example 800 shows a configured slot pattern of six slots. The network entity may transmit an indication of a repetition slot pattern. Example 800 shows that the repetition slot pattern is limited to a specified slot type (e.g., SBFD), in which the four repetitions are transmitted only in slots of the specified slot type. The TDD slot for uplink (UL) is not used. In some aspects, the specified slot type may be the slot type of the slot in which a repetition starts. For example, if a first repetition (either for a PUSCH or a PDSCH) is a full duplex slot (e.g., UL subband), the remaining slots used for the repetitions are limited to the full duplex slot type. The specified slot type to use may be based on a fixed slot offset from the scheduling DCI (to indicate the slot type) or the specified slot type may be the slot type of the first available slot. The indication from the network entity may be an RRC message (e.g., repetition=‘SBFD slot’) or DCI that explicitly specifies the specified slot type.

Example 802 shows a repetition slot pattern where the first three repetitions are transmitted in SBFD slot types, and the fourth repetition is transmitted in a TDD slot. However, the UE adapts the MCS and/or the transmit power in the TDD slot such that the target performance is more comparable to the SBFD slots.

As indicated above, FIG. 8 is provided as an example. Other examples may differ from what is described with regard to FIG. 8.

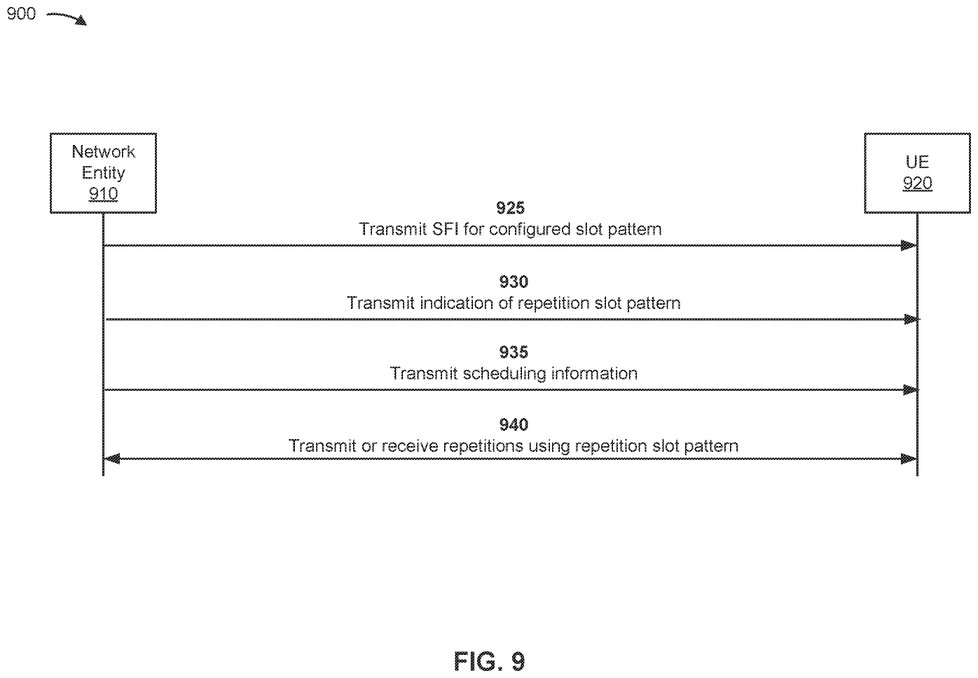

FIG. 9 is a diagram of an example 900 associated with indicating a repetition slot pattern, in accordance with the present disclosure. As shown in FIG. 9, a network entity 910 (e.g., a base station 110) may communicate with a UE 920 (e.g., a UE 120). In some aspects, the network entity 910 and the UE 920 may be part of a wireless network (e.g., the wireless network 100). The UE 920 and the network entity 910 may have established a wireless connection prior to operations shown in FIG. 9. The network entity 910 may be operating in an SBFD mode (e.g., transmitting and receiving at the same time on different frequency domain resources). In some aspects, the UE 920 may be operating in a half-duplex mode. In some other aspects, the UE 120 may be operating in a full-duplex mode.

As shown by reference number 925, the network entity 910 may transmit an SFI to indicate the configured slot pattern. As shown by reference number 930, the network entity 910 may transmit an indication of a repetition slot pattern for repetitions of a transport block. The repetition slot pattern may indicate the specified slot type for the repetitions explicitly or implicitly. An explicit indication may specify the specified slot type. An implicit indication may indicate that a slot type of an identified slot or a first available slot is to be the specified slot type.

As shown by reference number 935, the network entity 910 may transmit scheduling information that schedules the repetitions (or the transport blocks for the repetitions). The scheduling information may include DCI for dynamic scheduling or a higher-layer configuration. The higher-layer configuration may include an RRC message that configures SPS or CG. As shown by reference number 940, the network entity 910 and the UE 920 may transmit or receive repetitions of the transport block using the repetition slot pattern.

As indicated above, FIG. 9 is provided as an example. Other examples may differ from what is described with regard to FIG. 9.

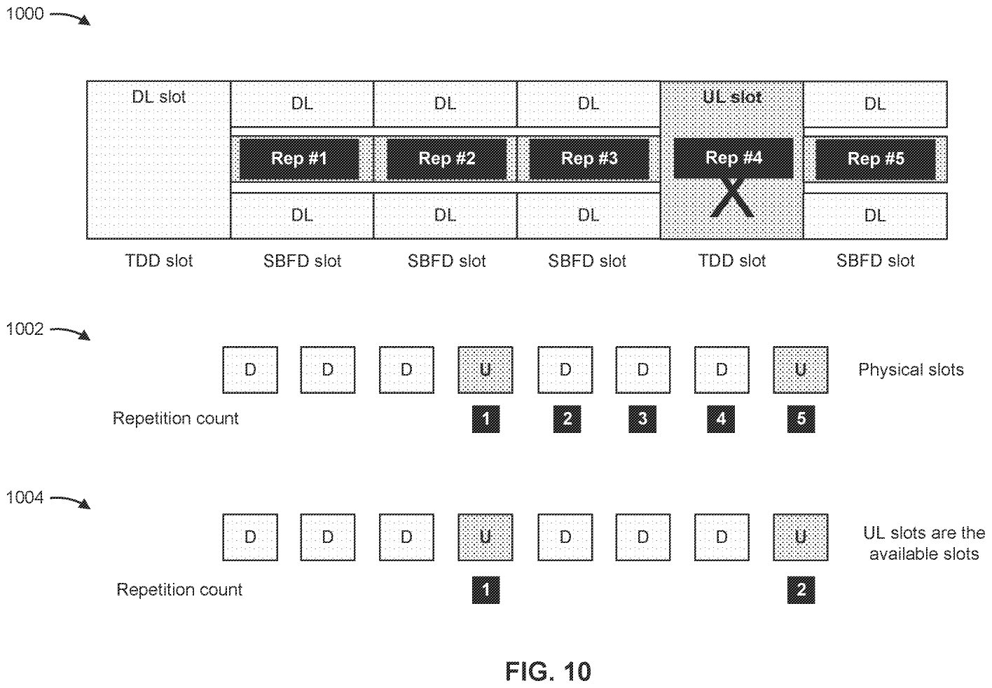

FIG. 10 is a diagram illustrating examples 1000, 1002, and 1004 of slot patterns for repetitions based on slot type, in accordance with the present disclosure.

Example 1000 shows a configured slot pattern of six slots. The UE may identify slots for five repetitions of a transport block (in a PDSCH or a PUSCH). In example 1000, these slots are the last five consecutive slots, which include three SBFD slots, a TDD slot (for PUSCH), and another SBFD slot. In some aspects, the UE may count the repetitions in slot types other than the specified slot type towards the repetition count for a transport block and drop (e.g., not transmit) the repetitions of the other slot types. In example 1000, the specified slot type is SBFD and thus repetition #4 in a TDD slot type is counted towards the repetition count for the transport block but dropped. Alternatively, the UE may not count the repetitions in slot types other than the specified slot type toward the repetition count for a transport block. The UE may still drop the repetitions of the other slot types. The counter may only count repetitions that are not dropped.

In some aspects, the counting may be for physical slots, which are slots that exist in time according to the configured slot pattern. Example 1002 shows an example of repetition counting in a configured TDD slot pattern with physical slots. The counting may start at a first slot and continue for five consecutive physical slots (repetition count: 5). In some aspects, the counting may be for only available slots. That is, the UE may identify slots based on time and/or frequency resource availability. Example 1004 shows an example of counting available slots. The two uplink slots are the available slots with unavailable slots in between. The counting may start at the first available slot and continue with any other available slots (repetition count: 2). The counting of physical slots or available slots may be for PDSCH repetitions or PUSCH repetitions.

In more detail, as a first option, if physical slot counting is enabled, then the UE may identify a set of contiguous (consecutive) slots for PUSCH or PDSCH repetitions. A repetition counter may be incremented in each slot. If a repetition occurs in a slot of another type (not of the specified slot type), the repetition is dropped. The slot type for which a repetition is dropped can be an uplink slot type, an SBFD slot type, or a downlink slot type. As a second option, if physical slot counting is enabled, then a set of contiguous slots are identified for PUSCH or PDSCH repetitions. If a repetition occurs in a slot of another slot type, the repetition is dropped. The repetition counter is incremented only if the repetition is not dropped.

As a third option, if available slot counting is enabled, the UE may identify a set of slots for PUSCH repetitions based on time and/or frequency resource availability. For PDSCH repetitions that are based on available slot counting, a slot is considered to be available if the slot has enough time and/or frequency resource for PDSCH transmissions based on RRC TDD-DL-UL slot pattern and UL-DL subband configurations. Note that a slot identified for PDSCH may not be contiguous. The repetition counter may be incremented in each identified slot. If a repetition occurs in a slot of another slot type, the repetition is dropped. As a fourth option, if available slot counting is enabled, the UE may identify a set of slots for PUSCH or PDSCH repetitions based on time and/or frequency resource availability. If a repetition occurs in a slot of another slot type, the repetition is dropped. The repetition counter may be incremented only if the repetition is not dropped. These options are examples and may not indicate any order of priority.

As indicated above, FIG. 10 is provided as an example. Other examples may differ from what is described with regard to FIG. 10.

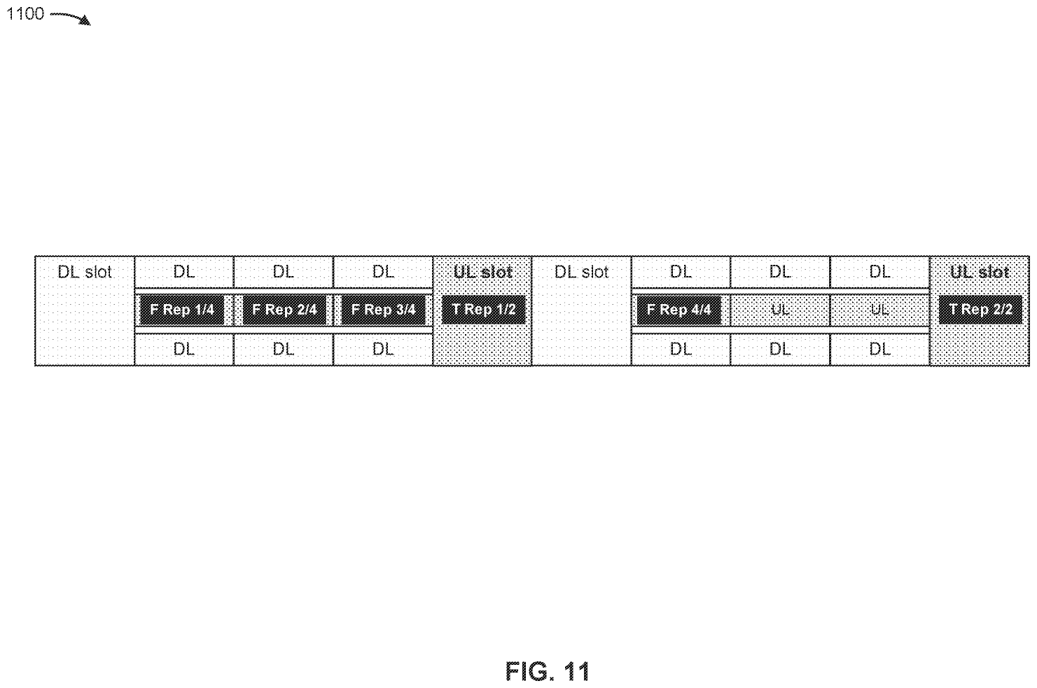

FIG. 11 is a diagram illustrating an example 1100 of splitting slot types for repetitions, in accordance with the present disclosure.

In some aspects, to overcome a low signal-to-interference and noise ratio (SINR) for SBFD slots, the network entity may indicate more repetitions for SBFD slots as compared to TDD slots. For example, the network entity may transmit an indication of a repetition slot pattern (for PUSCH or PDSCH) that splits repetitions for a transport block into two quantities for two slot types. The indication may indicate a first quantity N1 of repetitions for a first slot type (e.g., SBFD) and a second quantity N2 of repetitions for a second slot type (e.g., TDD). The sum of the N1 and N2 may be the total quantity of repetitions configured for a transport block.

Example 1100 shows a configured slot pattern of 10 slots. The network entity may transmit an indication specifying N1 to be 4 and N2 to be 2. Example 1100 shows “F Rep ¼” in an SBFD slot for 1 of 4 repetitions using SBFD slots. After 3 repetitions in SBFD slots, there is a “T Rep ½” in a TDD slot showing 1 of 2 repetitions using a TDD slot. Example 1100 further shows how the remaining repetitions are counted. The TDD and SBFD repetitions may have the same resource allocations or different resource allocations.

In some aspects, the network entity may provide the indication via RRC signaling in a time domain resource allocation (TDRA) table, in DCI, or in a medium access control control element (MAC CE). In some aspects, the TDRA table may have multiple sets (for N1 and N2) and DCI may explicitly point to one of the sets. In some aspects, the TDRA or DCI may indicate the total quantity N of repetitions for a transport block and for each N, there may be an RRC table specifying the values for N1 and N2. The UE may determine a size of the transport block by combining N1 and N2.

The UE may use a slot counter for each slot type. For example 1100, this may include a counter for SBFD slots and a counter for TDD slots. The use of separate counters may be applicable to available slot counting and may provide more flexibility and adaptation to existing configured slot patterns.

As indicated above, FIG. 11 is provided as an example. Other examples may differ from what is described with regard to FIG. 11.

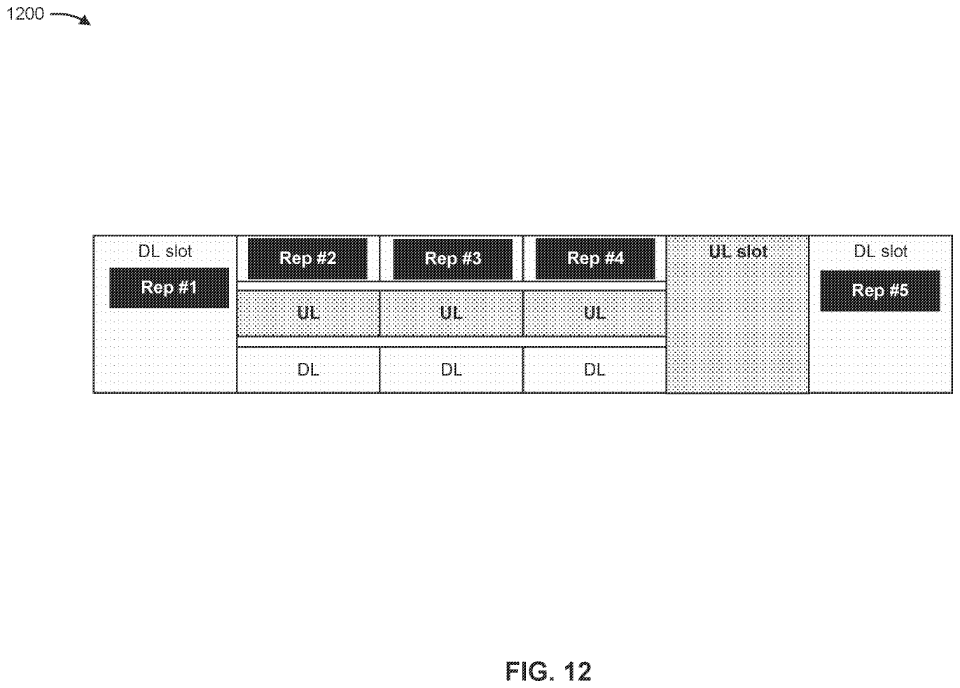

FIG. 12 is a diagram illustrating an example 1200 of scheduling repetitions, in accordance with the present disclosure.

In some aspects, when some of the frequency resources for SBFD slot repetitions are not available (e.g., guard band or the opposite direction subband), the UE may determine the transport block size to be the same for SBFD repetitions, and the UE may rate match (assign data for transmission) or puncture (use data scheduled for another communication) PxSCH communications for the non-available resources. Example 1200 shows repetitions that are transmitted in resources scheduled for PDSCH communications. In some aspects, the UE may scale a size of the transport block based on available resource blocks in the SBFD slot.

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120, UE 920) performs operations associated with using a repetition slot pattern for repetitions based on slot type.

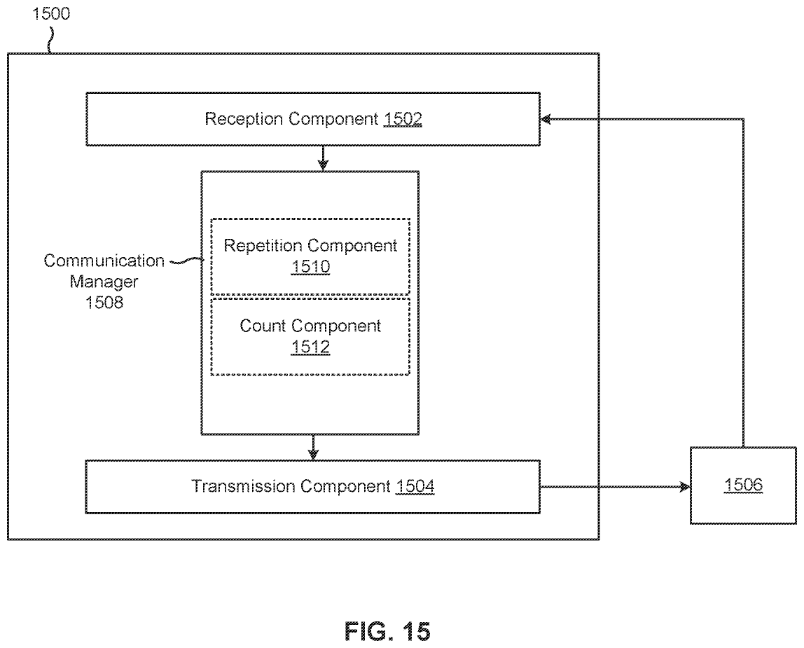

As shown in FIG. 13, in some aspects, process 1300 may include receiving an indication of a slot pattern for repetitions of a transport block in slots of a specified slot type (block 1310). For example, the UE (e.g., using communication manager 1508 and/or reception component 1502 depicted in FIG. 15) may receive an indication of a slot pattern for repetitions of a transport block in slots of a specified slot type, as described above.

As further shown in FIG. 13, in some aspects, process 1300 may include receiving scheduling information that schedules the repetitions (block 1320). For example, the UE (e.g., using communication manager 1508 and/or reception component 1502 depicted in FIG. 15) may receive scheduling information that schedules the repetitions, as described above.

As further shown in FIG. 13, in some aspects, process 1300 may include transmitting or receiving the repetitions according to the slot pattern based at least in part on the repetitions being for the specified slot type (block 1330). For example, the UE (e.g., using communication manager 1508 and/or transmission component 1504 depicted in FIG. 15) may transmit or receive the repetitions according to the slot pattern based at least in part on the repetitions being for the specified slot type, as described above.

Process 1300 may include additional aspects, such as any single aspect or any combination of aspects described below and/or in connection with one or more other processes described elsewhere herein.

In a first aspect, the repetitions are limited to the specified slot type and the specified slot type is based at least in part on a fixed slot type.

In a second aspect, alone or in combination with the first aspect, the repetitions are limited to the specified slot type and the specified slot type is based at least in part on a slot type of a first available slot or a slot type indicated by a slot offset from the scheduling information.

In a third aspect, alone or in combination with one or more of the first and second aspects, the repetitions are limited to the specified slot type and the scheduling information indicates the specified slot type.

In a fourth aspect, alone or in combination with one or more of the first through third aspects, process 1300 includes receiving a radio resource control message that configures the UE to use only the specified slot type.

In a fifth aspect, alone or in combination with one or more of the first through fourth aspects, the specified slot type is time division duplex or subband full duplex.

In a sixth aspect, alone or in combination with one or more of the first through fifth aspects, process 1300 includes counting repetitions in slots of other slot types than the specified slot type towards a repetition count for the transport block, and dropping the repetitions in the slots of other slot types.

In a seventh aspect, alone or in combination with one or more of the first through sixth aspects, process 1300 includes skipping counting of repetitions in slots of other slot types than the specified slot type towards a repetition count for the transport block, and dropping the repetitions in the slots of other slot types.

In an eighth aspect, alone or in combination with one or more of the first through seventh aspects, process 1300 includes counting repetitions in physical slots of the specified slot type and repetitions in physical slots of other slot types than the specified slot type towards a repetition count for the transport block.

In a ninth aspect, alone or in combination with one or more of the first through eighth aspects, the physical slots are consecutive physical slots.

In a tenth aspect, alone or in combination with one or more of the first through ninth aspects, the specified slot type is for transmission on a physical uplink shared channel.

In an eleventh aspect, alone or in combination with one or more of the first through tenth aspects, the specified slot type is for transmission on a physical downlink shared channel.

In a twelfth aspect, alone or in combination with one or more of the first through eleventh aspects, process 1300 includes counting repetitions in available slots of the specified slot type and repetitions in available slots of other slot types than the specified slot type towards a repetition count for the transport block.

In a thirteenth aspect, alone or in combination with one or more of the first through twelfth aspects, the specified slot type is for transmission on a physical uplink shared channel.

In a fourteenth aspect, alone or in combination with one or more of the first through thirteenth aspects, the specified slot type is for transmission on a physical downlink shared channel.

In a fifteenth aspect, alone or in combination with one or more of the first through fourteenth aspects, process 1300 includes counting repetitions in physical slots of the specified slot type towards a repetition count for the transport block, and skipping counting of repetitions in physical slots of other slot types than the specified slot type towards the repetition count of the transport block.

In a sixteenth aspect, alone or in combination with one or more of the first through fifteenth aspects, the specified slot type is for transmission on a physical uplink shared channel.

In a seventeenth aspect, alone or in combination with one or more of the first through sixteenth aspects, the specified slot type is for transmission on a physical downlink shared channel.

In an eighteenth aspect, alone or in combination with one or more of the first through seventeenth aspects, process 1300 includes counting repetitions in available slots of the specified slot type towards a repetition count for the transport block, and skipping counting of repetitions in available slots of other slot types than the specified slot type towards the repetition count of the transport block.

In a nineteenth aspect, alone or in combination with one or more of the first through eighteenth aspects, the specified slot type is for transmission on a physical uplink shared channel.

In a twentieth aspect, alone or in combination with one or more of the first through nineteenth aspects, the specified slot type is for transmission on a physical downlink shared channel.

In a twenty-first aspect, alone or in combination with one or more of the first through twentieth aspects, process 1300 includes dropping repetitions in slots of other slot types than the specified slot type.

In a twenty-second aspect, alone or in combination with one or more of the first through twenty-first aspects, the slots of the specified slot type are a first quantity of slots and repetitions in slots of another slot type are a second quantity of slots, and a sum of the first quantity of slots and the second quantity of slots equal a total repetition count for the transport block.

In a twenty-third aspect, alone or in combination with one or more of the first through twenty-second aspects, the specified slot type is subband full duplex and the other slot type is time division duplex.

In a twenty-fourth aspect, alone or in combination with one or more of the first through twenty-third aspects, process 1300 includes using a first counter for counting the repetitions in the slots of the specified slot type and a second counter for counting the repetitions in the slots of the other slot type.

In a twenty-fifth aspect, alone or in combination with one or more of the first through twenty-fourth aspects, process 1300 includes receiving an indication of an MCS for the specified slot type, where the MCS for the specified slot type is different than an MCS for another slot type, and determining a size of the transport block based at least in part on the MCS.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., base station 110, network entity 910) performs operations associated with indicating a repetition slot pattern for repetitions based on slot type.

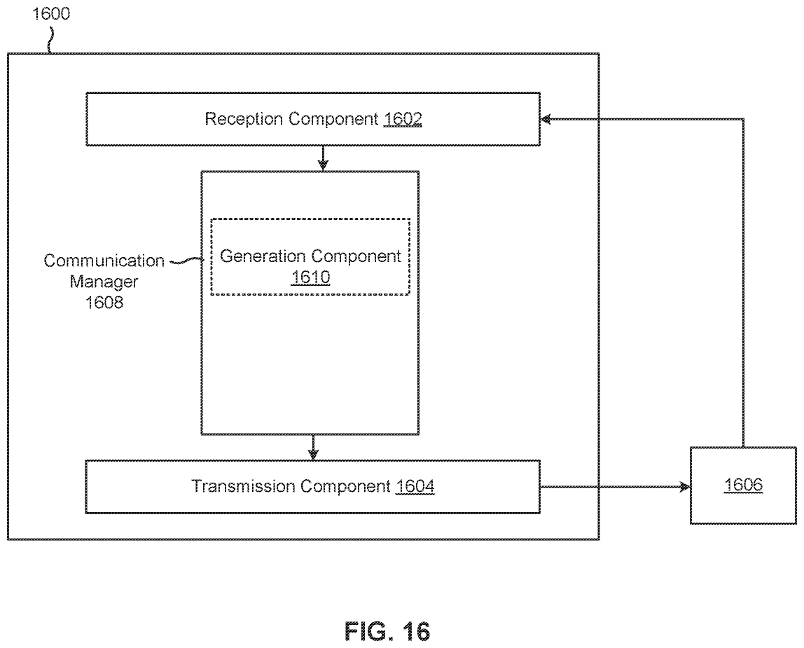

As shown in FIG. 14, in some aspects, process 1400 may include transmitting an indication of a slot pattern for repetitions of a transport block in slots of a specified slot type (block 1410). For example, the network entity (e.g., using communication manager 1608 and/or transmission component 1604 depicted in FIG. 16) may transmit an indication of a slot pattern for repetitions of a transport block in slots of a specified slot type, as described above.

As further shown in FIG. 14, in some aspects, process 1400 may include transmitting scheduling information that schedules the repetitions (block 1420). For example, the network entity (e.g., using communication manager 1608 and/or transmission component 1604 depicted in FIG. 16) may transmit scheduling information that schedules the repetitions, as described above.

As further shown in FIG. 14, in some aspects, process 1400 may include transmitting or receiving the repetitions according to the slot pattern based at least in part on the repetitions being for the specified slot type (block 1430). For example, the network entity (e.g., using communication manager 1608 and/or transmission component 1604 depicted in FIG. 16) may transmit or receive the repetitions according to the slot pattern based at least in part on the repetitions being for the specified slot type, as described above.

Process 1400 may include additional aspects, such as any single aspect or any combination of aspects described below and/or in connection with one or more other processes described elsewhere herein.

In a first aspect, the repetitions are limited to the specified slot type and the scheduling information indicates the specified slot type.

In a second aspect, alone or in combination with the first aspect, process 1400 includes transmitting an indication of an MCS for the specified slot type.

In a third aspect, alone or in combination with one or more of the first and second aspects, process 1400 includes transmitting, via a resource allocation or DCI, an indication of a first quantity of slots of the specified slot type and a second quantity of slots of another slot type.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE (e.g., UE 120, UE 920), or a UE may include the apparatus 1500. In some aspects, the apparatus 1500 includes a reception component 1502 and a transmission component 1504, which may be in communication with one another (e.g., via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 1508. The communication manager 1508 may control and/or otherwise manage one or more operations of the reception component 1502 and/or the transmission component 1504. In some aspects, the communication manager 1508 may include one or more antennas, a modem, a controller/processor, a memory, or a combination thereof, of the UE described in connection with FIG. 2. The communication manager 1508 may be, or be similar to, the communication manager 140 depicted in FIGS. 1 and 2. For example, in some aspects, the communication manager 1508 may be configured to perform one or more of the functions described as being performed by the communication manager 140. In some aspects, the communication manager 1508 may include the reception component 1502 and/or the transmission component 1504. The communication manager 140 may include one a repetition component 1510 and/or a count component 1512, among other examples.

In some aspects, the apparatus 1500 may be configured to perform one or more operations described herein in connection with FIGS. 1-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive an indication of a slot pattern for repetitions of a transport block in slots of a specified slot type. The reception component 1502 may receive scheduling information that schedules the repetitions. The transmission component 1504 may transmit or receive the repetitions according to the slot pattern based at least in part on the repetitions being for the specified slot type.

The reception component 1502 may receive a radio resource control message that configures the UE to use only the specified slot type. The repetition component 1510 may count repetitions in slots of other slot types than the specified slot type towards a repetition count for the transport block. The repetition component 1510 may drop the repetitions in the slots of other slot types.

The count component 1512 may skip counting of repetitions in slots of other slot types than the specified slot type towards a repetition count for the transport block. The repetition component 1510 may drop the repetitions in the slots of other slot types.

The count component 1512 may count repetitions in physical slots of the specified slot type and repetitions in physical slots of other slot types than the specified slot type towards a repetition count for the transport block. The count component 1512 may count repetitions in available slots of the specified slot type and repetitions in available slots of other slot types than the specified slot type towards a repetition count for the transport block.

The count component 1512 may count repetitions in physical slots of the specified slot type towards a repetition count for the transport block. The count component 1512 may skip counting of repetitions in physical slots of other slot types than the specified slot type towards the repetition count of the transport block.

The count component 1512 may count repetitions in available slots of the specified slot type towards a repetition count for the transport block. The count component 1512 may skip counting of repetitions in available slots of other slot types than the specified slot type towards the repetition count of the transport block. The repetition component 1510 may drop repetitions in slots of other slot types than the specified slot type.

The count component 1512 may use a first counter for counting the repetitions in the slots of the specified slot type and a second counter for counting the repetitions in the slots of the other slot type.

The reception component 1502 may receive an indication of a modulation and coding scheme (MCS) for the specified slot type, wherein the MCS for the specified slot type is different than an MCS for another slot type. The repetition component 1510 may determine a size of the transport block based at least in part on the MCS.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network entity (e.g., base station 110, network entity 910), or a network entity may include the apparatus 1600. In some aspects, the apparatus 1600 includes a reception component 1602 and a transmission component 1604, which may be in communication with one another (e.g., via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the network entity described in connection with FIG. 2. The communication manager 1608 may be, or be similar to, the communication manager 150 depicted in FIGS. 1 and 2. For example, in some aspects, the communication manager 1608 may be configured to perform one or more of the functions described as being performed by the communication manager 150. In some aspects, the communication manager 1608 may include the reception component 1602 and/or the transmission component 1604. The communication manager 1608 may include a generation component 1610, among other examples.

In some aspects, the apparatus 1600 may be configured to perform one or more operations described herein in connection with FIGS. 1-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The transmission component 1604 may transmit an indication of a slot pattern for repetitions of a transport block in slots of a specified slot type. The generation component 1610 may generate the indication based at least in part on a configured slot pattern, a transport block size, traffic conditions, channel conditions, a UE capability, and/or slot type configurations. The transmission component 1604 may transmit scheduling information that schedules the repetitions. The transmission component 1604 may transmit or receive the repetitions according to the slot pattern based at least in part on the repetitions being for the specified slot type.

The transmission component 1604 may transmit an indication of an MCS for the specified slot type. The transmission component 1604 may transmit, via a resource allocation or downlink control information, an indication of a first quantity of slots of the specified slot type and a second quantity of slots of another slot type.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a user equipment (UE), comprising: receiving an indication of a slot pattern for repetitions of a transport block in slots of a specified slot type; receiving scheduling information that schedules the repetitions; and transmitting or receiving the repetitions according to the slot pattern based at least in part on the repetitions being for the specified slot type.
Aspect 2: The method of Aspect 1, wherein the repetitions are limited to the specified slot type and the specified slot type is based at least in part on a fixed slot type.
Aspect 3: The method of Aspect 1, wherein the repetitions are limited to the specified slot type and the specified slot type is based at least in part on a slot type of a first available slot or a slot type indicated by a slot offset from the scheduling information.
Aspect 4: The method of Aspect 1, wherein the repetitions are limited to the specified slot type and the scheduling information indicates the specified slot type.
Aspect 5: The method of any of Aspects 1-4, further comprising receiving a radio resource control message that configures the UE to use only the specified slot type.
Aspect 6: The method of any of Aspects 1-5, wherein the specified slot type is time division duplex or subband full duplex.
Aspect 7: The method of any of Aspects 1-6, further comprising: counting repetitions in slots of other slot types than the specified slot type towards a repetition count for the transport block; and dropping the repetitions in the slots of other slot types.
Aspect 8: The method of any of Aspects 1-6, further comprising: skipping counting of repetitions in slots of other slot types than the specified slot type towards a repetition count for the transport block; and dropping the repetitions in the slots of other slot types.
Aspect 9: The method of any of Aspects 1-6, further comprising counting repetitions in physical slots of the specified slot type and repetitions in physical slots of other slot types than the specified slot type towards a repetition count for the transport block.
Aspect 10: The method of Aspect 9, wherein the physical slots are consecutive physical slots.
Aspect 11: The method of Aspect 9, wherein the specified slot type is for transmission on a physical uplink shared channel.
Aspect 12: The method of Aspect 9, wherein the specified slot type is for transmission on a physical downlink shared channel.
Aspect 13: The method of any of Aspects 1-6, further comprising counting repetitions in available slots of the specified slot type and repetitions in available slots of other slot types than the specified slot type towards a repetition count for the transport block.
Aspect 14: The method of Aspect 13, wherein the specified slot type is for transmission on a physical uplink shared channel.
Aspect 15: The method of Aspect 13, wherein the specified slot type is for transmission on a physical downlink shared channel.
Aspect 16: The method of any of Aspects 1-6, further comprising: counting repetitions in physical slots of the specified slot type towards a repetition count for the transport block; and skipping counting of repetitions in physical slots of other slot types than the specified slot type towards the repetition count of the transport block.
Aspect 17: The method of Aspect 16, wherein the specified slot type is for transmission on a physical uplink shared channel.
Aspect 18: The method of Aspect 16, wherein the specified slot type is for transmission on a physical downlink shared channel.
Aspect 19: The method of any of Aspects 1-6, further comprising: counting repetitions in available slots of the specified slot type towards a repetition count for the transport block; and skipping counting of repetitions in available slots of other slot types than the specified slot type towards the repetition count of the transport block.
Aspect 20: The method of Aspect 19, wherein the specified slot type is for transmission on a physical uplink shared channel.
Aspect 21: The method of Aspect 19, wherein the specified slot type is for transmission on a physical downlink shared channel.
Aspect 22: The method of any of Aspects 1-212, further comprising dropping repetitions in slots of other slot types than the specified slot type.
Aspect 23: The method of any of Aspects 1-22, wherein the slots of the specified slot type are a first quantity of slots and repetitions in slots of another slot type are a second quantity of slots, and wherein a sum of the first quantity of slots and the second quantity of slots equal a total repetition count for the transport block.
Aspect 24: The method of Aspect 23, wherein the specified slot type is subband full duplex and the other slot type is time division duplex.
Aspect 25: The method of Aspect 23 or 24, further comprising using a first counter for counting the repetitions in the slots of the specified slot type and a second counter for counting the repetitions in the slots of the other slot type.
Aspect 26: The method of Aspect 7-25, further comprising: receiving an indication of a modulation and coding scheme (MCS) for the specified slot type, wherein the MCS for the specified slot type is different than an MCS for another slot type; and determining a size of the transport block based at least in part on the MCS.
Aspect 27: A method of wireless communication performed by a network entity, comprising: transmitting an indication of a slot pattern for repetitions of a transport block in slots of a specified slot type; transmitting scheduling information that schedules the repetitions; and transmitting or receiving the repetitions according to the slot pattern based at least in part on the repetitions being for the specified slot type.
Aspect 28: The method of Aspect 27, wherein the repetitions are limited to the specified slot type and the scheduling information indicates the specified slot type.
Aspect 29: The method of Aspect 27 or 28, further comprising transmitting an indication of a modulation and coding scheme (MCS) for the specified slot type.
Aspect 30: The method of any of Aspects 27-29, further comprising transmitting, via a resource allocation or downlink control information, an indication of a first quantity of slots of the specified slot type and a second quantity of slots of another slot type.
Aspect 31: An apparatus for wireless communication at a device, comprising a processor; memory coupled with the processor; and instructions stored in the memory and executable by the processor to cause the apparatus to perform the method of one or more of Aspects 1-30.
Aspect 32: A device for wireless communication, comprising a memory and one or more processors coupled to the memory, the one or more processors configured to perform the method of one or more of Aspects 1-30.
Aspect 33: An apparatus for wireless communication, comprising at least one means for performing the method of one or more of Aspects 1-30.
Aspect 34: A non-transitory computer-readable medium storing code for wireless communication, the code comprising instructions executable by a processor to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of a slot pattern for repetitions of a transport block in slots of a specified slot type;
receive scheduling information that schedules the repetitions; and
transmit or receive the repetitions according to the slot pattern based at least in part on the repetitions being for the specified slot type.

2. The UE of claim 1, wherein the repetitions are limited to the specified slot type and the specified slot type is based at least in part on a fixed slot type.

3. The UE of claim 1, wherein the repetitions are limited to the specified slot type and the specified slot type is based at least in part on a slot type of a first available slot or a slot type indicated by a slot offset from the scheduling information.

4. The UE of claim 1, wherein the repetitions are limited to the specified slot type and the scheduling information indicates the specified slot type.

5. The UE of claim 1, wherein the one or more processors are configured to receive a radio resource control message that configures the UE to use only the specified slot type.

6. The UE of claim 1, wherein the specified slot type is time division duplex or subband full duplex.

7. The UE of claim 1, wherein the one or more processors are configured to:
count repetitions in slots of other slot types than the specified slot type towards a repetition count for the transport block; and
drop the repetitions in the slots of other slot types.

8. The UE of claim 1, wherein the one or more processors are configured to:
skip counting of repetitions in slots of other slot types than the specified slot type towards a repetition count for the transport block; and
drop the repetitions in the slots of other slot types.

9. The UE of claim 1, wherein the one or more processors are configured to count repetitions in physical slots of the specified slot type and repetitions in physical slots of other slot types than the specified slot type towards a repetition count for the transport block.

10. The UE of claim 9, wherein the physical slots are consecutive physical slots.

11. The UE of claim 9, wherein the specified slot type is for transmission on a physical uplink shared channel.

12. The UE of claim 9, wherein the specified slot type is for transmission on a physical downlink shared channel.

13. The UE of claim 1, wherein the one or more processors are configured to count repetitions in available slots of the specified slot type and repetitions in available slots of other slot types than the specified slot type towards a repetition count for the transport block.

14. The UE of claim 13, wherein the specified slot type is for transmission on a physical uplink shared channel.

15. The UE of claim 13, wherein the specified slot type is for transmission on a physical downlink shared channel.

16. The UE of claim 1, wherein the one or more processors are configured to:
count repetitions in physical slots of the specified slot type towards a repetition count for the transport block; and
skip counting of repetitions in physical slots of other slot types than the specified slot type towards the repetition count of the transport block.

17. The UE of claim 16, wherein the specified slot type is for transmission on a physical uplink shared channel.

18. The UE of claim 16, wherein the specified slot type is for transmission on a physical downlink shared channel.

19. The UE of claim 1, wherein the one or more processors are configured to:
count repetitions in available slots of the specified slot type towards a repetition count for the transport block; and
skip counting of repetitions in available slots of other slot types than the specified slot type towards the repetition count of the transport block.

20. The UE of claim 19, wherein the specified slot type is for transmission on a physical uplink shared channel.

21. The UE of claim 19, wherein the specified slot type is for transmission on a physical downlink shared channel.

22. The UE of claim 1, wherein the one or more processors are configured to drop repetitions in slots of other slot types than the specified slot type.

23. The UE of claim 1, wherein the slots of the specified slot type are a first quantity of slots and repetitions in slots of another slot type are a second quantity of slots, and wherein a sum of the first quantity of slots and the second quantity of slots equal a total repetition count for the transport block.

24. The UE of claim 23, wherein the specified slot type is subband full duplex and the other slot type is time division duplex.

25. The UE of claim 23, wherein the one or more processors are further configured to use a first counter for counting the repetitions in the slots of the specified slot type and a second counter for counting the repetitions in the slots of the other slot type.

26. The UE of claim 1, wherein the one or more processors are configured to:
receive an indication of a modulation and coding scheme (MCS) for the specified slot type, wherein the MCS for the specified slot type is different than an MCS for another slot type; and
determine a size of the transport block based at least in part on the MCS.

27. A network entity for wireless communication, comprising:
a memory; and
one or more processors, coupled to the memory, configured to:
transmit an indication of a slot pattern for repetitions of a transport block in slots of a specified slot type;
transmit scheduling information that schedules the repetitions; and
transmit or receive the repetitions according to the slot pattern based at least in part on the repetitions being for the specified slot type.

28. The network entity of claim 27, wherein the repetitions are limited to the specified slot type and the scheduling information indicates the specified slot type.

29. The network entity of claim 27, wherein the one or more processors are configured to transmit an indication of a modulation and coding scheme (MCS) for the specified slot type.

30. The network entity of claim 27, wherein the one or more processors are configured to transmit, via a resource allocation or downlink control information, an indication of a first quantity of slots of the specified slot type and a second quantity of slots of another slot type.
